(19) United States
(12) Patent Application Publication
(10) Pub. No.: US 2026/0267799 A1
(43) Pub. Date: Sep. 10, 2026

(54) CACHE SLOT DONATION DURING IO BURSTS

(71) Applicant: Dell Products L.P., Round Rock, TX (US)

(72) Inventors: Kaustubh Sahasrabudhe, Westborough, MA (US); Steve Ivester, Grafton, MA (US); Ramesh Doddaiah, Westborough, MA (US)

(73) Assignee: Dell Products L.P., Round Rock, TX (US)

(21) Appl. No.: 19/075,199

(22) Filed: Mar. 10, 2025

(51) Int. Cl. G06F 12/0802

(52) U.S. Cl. CPC G06F 12/0802; G06F 12/0646; G06F 2212/60

(57) ABSTRACT

One or more aspects of the present disclosure relate to dynamic cache slot management in storage systems. Performance statistics for cache memory segments are analyzed to forecast input/output (IO) activity periods using time-series analysis. Based on the forecasts, source segments having available cache slots and target segments requiring additional cache slots are identified. A donation schedule is determined for temporarily transferring cache slots between segments during predicted IO burst periods, with transfers occurring both within individual boards and across multiple boards. The system monitors various to optimize the timing and quantity of cache slot donations. Cache slots can be transferred between mirrored segments, non-mirrored segments, or between mirrored and non-mirrored segments based on workload demands. The transfers are managed through pre-formatting of memory banks and coordinated signaling when slots are ready for use, with donations automatically terminating when the forecasted IO burst period concludes.

### BACKGROUND

Storage systems employ segmented cache memory pools with varying sizes to handle different types of input/output (IO) operations. These systems utilize mirrored and non-mirrored cache segments, where mirrored segments maintain redundant copies for write operations while non-mirrored segments handle read operations. The cache memory is distributed across multiple boards and engines, with each board containing local memory banks organized into segments of different sizes (e.g., 8K, 16K, 128K) to accommodate various IO profiles and workload characteristics. Cache replacement algorithms traditionally manage these segments using round-robin approaches across local memory banks, while a dynamic cache balancing mechanism periodically adjusts segment sizes based on longer-term workload patterns.

### SUMMARY

One or more aspects of the present disclosure relate to dynamic cache slot management in storage systems. In embodiments, performance statistics for cache memory segments are analyzed to forecast input/output (IO) activity periods. Based on the forecasted IO activity periods, source segments having available cache slots and target segments requiring additional cache slots are identified. Additionally, a donation schedule for temporarily transferring cache slots from the source segments to the target segments during the forecasted IO activity periods is determined. Further, the cache slots are transferred according to the donation schedule.

In embodiments, a time and duration of IO bursts can be predicted using a time-series analysis.

In embodiments, the performance statistics can include at least one of: CPU consumption, bandwidth consumption, segment-level allocations, fault tolerance, and IO profiles.

In embodiments, transferring cache slots can include transferring between at least one of: mirrored segments, non-mirrored segments, and mirrored and non-mirrored segments.

In embodiments, determining the donation schedule can include identifying idle processing periods and available bandwidth windows and scheduling cache slot transfers during the identified idle periods.

In embodiments, memory banks in the source segments can be pre-formatted before transferring the cache slots.

In embodiments, transferring cache slots can include transferring cache slots between segments on a same board and transferring cache slots between segments on different boards.

In embodiments, when transferred cache slots are ready for use can be signaled. In addition, the transfers can be terminated when the forecasted IO activity period concludes

In embodiments, analyzing performance statistics can include monitoring IO activity within individual boards and monitoring IO activity across multiple boards.

In embodiments, determining the donation schedule can include determining a quantity of cache slots to transfer based on forecasted IO activity levels.

Other technical features may be readily apparent to one skilled in the art from the following figures, descriptions, and claims.

### BRIEF DESCRIPTION OF THE DRAWINGS

The preceding and other objects, features, and advantages will be apparent from the following more particular description of the embodiments, as illustrated in the accompanying drawings. Like reference, characters refer to the same parts throughout the different views. The drawings are not necessarily to scale, emphasis instead being placed upon illustrating the embodiments' principles.

FIG. 1 illustrates a distributed network environment in accordance with embodiments of the present disclosure.

FIG. 2 is a cross-sectional view of a storage device in accordance with embodiments of the present disclosure.

FIG. 3 is a block diagram of engines of a storage array, including director boards, in accordance with embodiments of the present disclosure.

FIG. 4 is a block diagram of cache memory segments of director boards in accordance with embodiments of the present disclosure.

FIG. 5 is a block diagram of a controller in accordance with embodiments of the present disclosure.

FIG. 6 is a flow diagram of a method for dynamic managing cache slots per embodiments of the present disclosure.

FIG. 7 is a flow diagram of a method for enabling coordinated cache slot donations between local and remote boards in accordance with embodiments of the present disclosure.

### DETAILED DESCRIPTION

Modern storage systems employ sophisticated cache memory management techniques for varying input/output (IO) workloads. These systems utilize segmented cache pools of different sizes (8K, 16K, 128K) in both mirrored configurations for write operations and non-mirrored configurations for read operations, distributed across multiple boards and engines.

Traditional cache replacement algorithms use a round-robin approach across local memory banks, which can lead to significant inefficiencies during periods of intense IO activity. When smaller segments become overutilized, the system must allocate slots from larger segments or aggressively recycle existing slots, resulting in increased CPU overhead and degraded performance. For example, when a major bank processes end-of-day transactions, its systems experience intense bursts of 16K-sized IO operations. These financial workloads create imbalanced loads across cache segments, where certain pools become overwhelmed while others remain underutilized. The current dynamic cache balancing (DCB) mechanism operates on 4-hour time windows, making it unable to effectively respond to short-term IO bursts that can cause sudden spikes in resource demands.

Consider a bank transaction scenario where the system needs to process numerous 16K-sized operations. Traditional cache management approaches struggle when the Mirrored 16K pool becomes saturated, forcing allocation from larger 128K pools and leading to inefficient memory usage. This situation is particularly problematic during peak banking hours, such as the 8:00-9:00 AM and 4:00-5:00 PM windows when transaction volumes spike.

Embodiments of the present disclosure provide methods and systems for dynamic cache slot management during IO burst periods. The embodiments employ AutoRegressive Integrated Moving Average (ARIMA) time-series analysis to forecast IO activity patterns, monitoring key metrics, including CPU consumption, bandwidth utilization, segment-level allocations, and fault tolerance. Based on these forecasts, the embodiments identify source segments with available cache slots and target segments requiring additional capacity, establishing a temporary donation schedule that spans local and remote boards.

The embodiments enable cache slot transfers between mirrored segments, non-mirrored segments, or between mirrored and non-mirrored segments, with donations occurring at both the board level and across multiple boards/engines. Before initiating transfers, the embodiments pre-format memory banks in target segments and implement coordinated signaling mechanisms to ensure smooth transitions. The donation process continues until the forecasted IO burst period concludes, at which point borrowed cache slots are returned to their original segments.

This dynamic donation mechanism can operate alongside the existing DCB system, providing fine-grained resource management during burst periods while maintaining longer-term cache balance. The embodiments carefully consider fabric bandwidth consumption and latency impacts when coordinating cross-board donations, optimizing the timing and quantity of cache slot transfers to minimize system overhead. By enabling proactive resource sharing during peak demand periods, the embodiments significantly improve memory utilization, reduce CPU overhead, and enhance overall system performance for storage arrays experiencing imbalanced IO workloads.

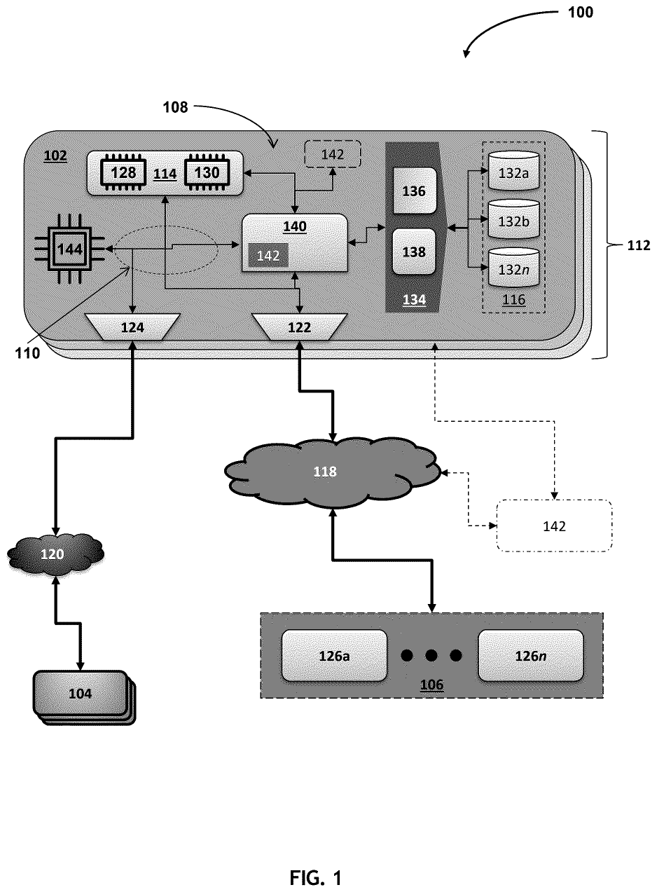

Regarding FIG. 1, a distributed network environment 100 can include a storage array 102, a remote system 104, and hosts 106. In embodiments, the storage array 102 can include components 108 that perform one or more distributed file storage services. In addition, the storage array 102 can include one or more internal communication channels 110 like Fibre channels, busses, and communication modules that communicatively couple the components 108. Further, the distributed network environment 100 can define an array cluster 112, including the storage array 102 and one or more other storage arrays.

In embodiments, the storage array 102, components 108, and remote system 104 can include a variety of proprietary or commercially available single or multi-processor systems (e.g., parallel processor systems). Single or multi-processor systems can include central processing units (CPUs), graphical processing units (GPUs), and others. Additionally, the storage array 102, remote system 104, and hosts 106 can virtualize one or more of their respective physical computing resources (e.g., processors (not shown), memory 114, and persistent storage 116).

In embodiments, the storage array 102 and, e.g., one or more hosts 106 (e.g., networked devices) can establish a network 118. Similarly, the storage array 102 and a remote system 104 can establish a remote network 120. Further, the network 118 or the remote network 120 can have a network architecture that enables networked devices to send/receive electronic communications using a communications protocol. For example, the network architecture can define a storage area network (SAN), local area network (LAN), wide area network (WAN) (e.g., the Internet), an Explicit Congestion Notification (ECN), Enabled Ethernet network, and the like. Additionally, the communications protocol can include a Remote Direct Memory Access (RDMA), TCP, IP, TCP/IP protocol, SCSI, Fibre Channel, Remote Direct Memory Access (RDMA) over Converged Ethernet (ROCE) protocol, Internet Small Computer Systems Interface (ISCSI) protocol, NVMe-over-fabrics protocol (e.g., NVMe-over-ROCEv2 and NVMe-over-TCP), and the like.

Further, the storage array 102 can connect to the network 118 or remote network 120 using one or more network interfaces. The network interface can include a wired/wireless connection interface, bus, data link, and the like. For example, a host adapter (HA 122), e.g., a Fibre Channel Adapter (FA) and the like, can connect the storage array 102 to the network 118 (e.g., SAN). Further, the HA 122 can receive and direct IOs to one or more of the storage array's components 108, as described in greater detail herein.

Likewise, a remote adapter (RA 124) can connect the storage array 102 to the remote network 120. Further, the network 118 and remote network 120 can include communication mediums and nodes that link the networked devices. For example, communication mediums can include cables, telephone lines, radio waves, satellites, infrared light beams, etc. The communication nodes can also include switching equipment, phone lines, repeaters, multiplexers, and satellites. Further, the network 118 or remote network 120 can include a network bridge that enables cross-network communications between, e.g., the network 118 and remote network 120.

In embodiments, hosts 106 connected to the network 118 can include client machines 126a-n, running one or more applications. The applications can require one or more of the storage array's services. Accordingly, each application can send one or more input/output (IO) messages (e.g., a read/write request or other storage service-related request) to the storage array 102 over the network 118. Further, the IO messages can include metadata defining performance requirements according to a service level agreement (SLA) between hosts 106 and the storage array provider.

In embodiments, the storage array 102 can include a memory 114, such as volatile or nonvolatile memory. Further, volatile and nonvolatile memory can include random access memory (RAM), dynamic RAM (DRAM), static RAM (SRAM), and the like. Moreover, each memory type can have distinct performance characteristics (e.g., speed corresponding to reading/writing data). For instance, the types of memory can include register, shared, constant, user-defined, and the like. Furthermore, in embodiments, the memory 114 can include global memory (GM 128) that can cache IO messages and their respective data payloads. Additionally, the memory 114 can include local memory (LM 130) that stores instructions that the storage array's processors 144 can execute to perform one or more storage-related services. For example, the storage array 102 can have a multi-processor architecture that includes one or more CPUs (central processing units) and GPUs (graphical processing units).

In addition, the storage array 102 can deliver its distributed storage services using persistent storage 116. For example, the persistent storage 116 can include multiple thin-data devices (TDATs) such as persistent storage drives 132a-n. Further, each TDAT can have distinct performance capabilities (e.g., read/write speeds) like hard disk drives (HDDs) and solid-state drives (SSDs).

Further, the HA 122 can direct one or more IOs to an array component 108 based on their respective request types and metadata. In embodiments, the storage array 102 can include a device interface (DI 134) that manages access to the array's persistent storage 116. For example, the DI 134 can include a disk adapter (DA 136) (e.g., storage device controller), flash drive interface 138, and the like that control access to the array's persistent storage 116 (e.g., storage devices 132a-n).

Likewise, the storage array 102 can include an Enginuity Data Services processor (EDS 140) that can manage access to the array's memory 114. Further, the EDS 140 can perform one or more memory and storage self-optimizing operations (e.g., one or more machine learning techniques) that enable fast data access. Specifically, the operations can implement techniques that deliver performance, resource availability, data integrity services, and the like based on the SLA and the performance characteristics (e.g., read/write times) of the array's memory 114 and persistent storage 116. For example, the EDS 140 can deliver hosts 106 (e.g., client machines 126a-n) remote/distributed storage services by virtualizing the storage array's memory/storage resources (memory 114 and persistent storage 116, respectively).

In embodiments, the storage array 102 can also include a controller 142 (e.g., management system controller) that can reside externally from or within the storage array 102 and one or more of its components 108. When external from the storage array 102, the controller 142 can communicate with the storage array 102 using any known communication connections. For example, the communications connections can include a serial port, parallel port, network interface card (e.g., Ethernet), etc. Further, the controller 142 can include logic/circuitry that performs one or more storage-related services. For example, the controller 142 can have an architecture designed to manage the storage array's computing, processing, storage, and memory resources as described in greater detail herein.

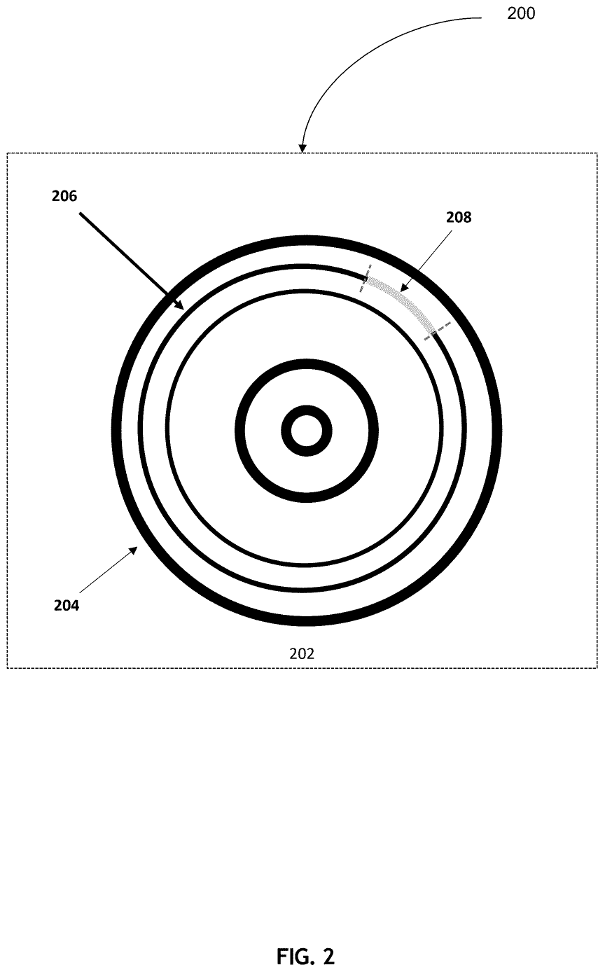

Regarding FIG. 2, the storage array's EDS 140 can virtualize the array's persistent storage 116. Specifically, the EDS 140 can virtualize a storage device 200, which is substantially like one or more of the storage devices 132a-n. For example, the EDS 140 can provide a host, e.g., client machine 126a, with a virtual storage device (e.g., thin-device (TDEV)) that logically represents zero or more portions of each storage device 132a-n. For example, the EDS 140 can establish a logical track using zero or more physical address spaces from each storage device 132a-n. Specifically, the EDS 140 can establish a continuous set of logical block addresses (LBA) using physical address spaces from the storage devices 132a-n. Thus, each (LBA) represents a corresponding physical address space from one of the storage devices 132a-n. For example, a track can include 256 LBAs, amounting to 128 kb of physical storage space. Further, the EDS 140 can establish the TDEV using several tracks based on the desired storage capacity of the TDEV. The EDS 140 can also establish extents that logically define a group of tracks.

In embodiments, the EDS 140 can provide each TDEV with a unique identifier (ID) like a target ID (TID). Additionally, EDS 140 can establish a logical unit number (LUN) that maps each track of a TDEV to its corresponding physical track location using pointers. Further, the EDS 140 can also generate a searchable data structure, mapping logical storage representations to their corresponding physical address spaces. Thus, EDS 100 can enable the HA 122 to present the hosts 106 with the logical storage representations based on host or application performance requirements.

For example, the persistent storage 116 can include an HDD 202 with stacks of cylinders 204. Like a vinyl record's grooves, each cylinder 204 can include one or more tracks 206. Each track 206 can include continuous sets of physical address spaces representing each of its sectors 208 (e.g., slices or portions thereof). The EDS 140 can provide each slice/portion with a corresponding logical block address (LBA). The EDS 140 can also group sets of continuous LBAs to establish one or more tracks. Further, the EDS 140 can group a set of tracks to establish each extent of a virtual storage device (e.g., TDEV). Thus, each TDEV can include tracks and LBAs corresponding to one or more of the persistent storage 116 or portions thereof (e.g., tracks and address spaces).

As stated herein, the persistent storage 116 can have distinct performance capabilities. For example, an HDD architecture is known by skilled artisans to be slower than an SSD's architecture. Likewise, the array's memory 114 can include different memory types, each with distinct performance characteristics described herein. In embodiments, the EDS 140 can establish a storage or memory hierarchy based on the SLA and the performance characteristics of the array's memory/storage resources. For example, the SLA can include one or more Service Level Objectives (SLOs) specifying performance metric ranges (e.g., response times and uptimes) corresponding to the hosts' performance requirements.

Further, the SLO can specify service level (SL) tiers corresponding to each performance metric range and categories of data importance (e.g., critical, high, medium, low). For example, the SLA can map critical data types to an SL tier requiring the fastest response time. Thus, the storage array 102 can allocate the array's memory/storage resources based on an IO workload's anticipated volume of IO messages associated with each SL tier and the memory hierarchy.

For example, the EDS 140 can establish the hierarchy to include one or more tiers (e.g., subsets of the array's storage and memory) with similar performance capabilities (e.g., response times and uptimes). Thus, the EDS 140 can establish fast memory and storage tiers to service host-identified critical and valuable data (e.g., Platinum, Diamond, and Gold SLs). In contrast, slow memory and storage tiers can service host-identified, non-critical, less valuable data (e.g., Silver and Bronze SLs). The EDS 140 can also define “fast” and “slow” performance metrics based on relative performance measurements of the array's memory 114 and persistent storage 116. Thus, the fast tiers can include memory 114 and persistent storage 116, with relative performance capabilities exceeding a first threshold. In contrast, slower tiers can include memory 114 and persistent storage 116, with relative performance capabilities falling below a second threshold. Further, the first and second thresholds can correspond to the same threshold.

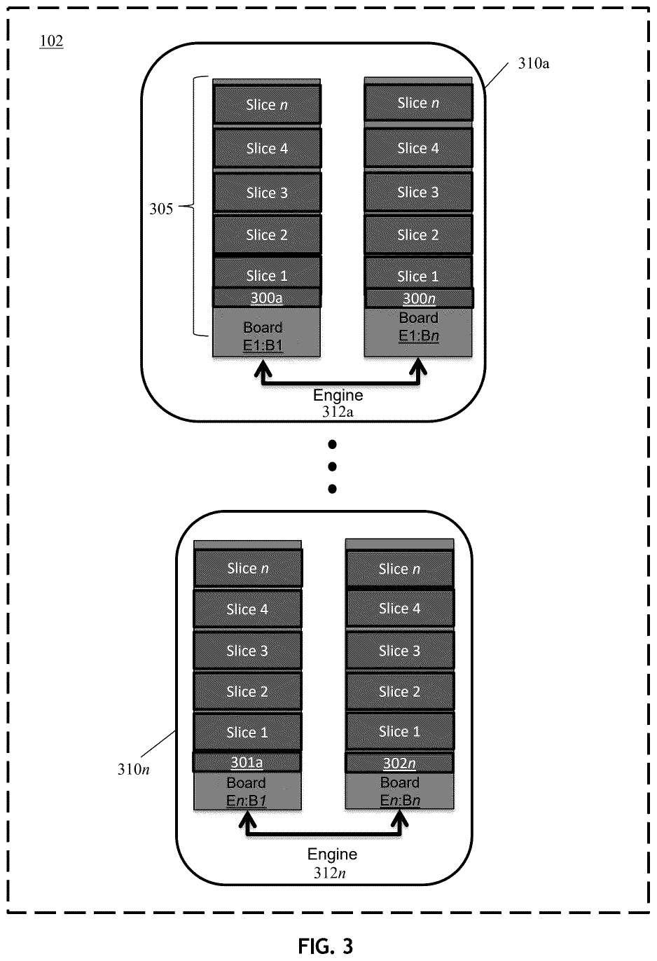

Regarding FIG. 3, the storage array 102 includes engines 312a-n that deliver storage services. Each engine 312a-n has hardware circuity or software components required to perform the storage services. Additionally, the array 102 can house each engine 312a-n in one or more of its shelves (e.g., housing) 310a-n that interface with the array's cabinet or rack (not shown).

In embodiments, each engine 312a-n can include director boards (boards) E1:B1-E1:Bn, En:B1-En:Bn. The boards E1:B1-E1:Bn, En:B1-En:Bn can have slices 305, each comprising hardware or software elements that perform specific storage services. Each board's slices 1-n can correspond to or emulate one or more of the storage array's components 108 described in FIG. 1. For example, each board's Slice 1 can correspond to or emulate the EDS 140 or controller 142 of FIG. 1. In embodiments, the slices 2-n can emulate one or more of the array's other components 101. Further, the boards B1-n can include memory 300a-n-301a-n, respectively. The memory 300a-n-301a-n can be dynamic random-access memory (DRAM).

In embodiments, each emulated EDS 140 (collectively “EDS 140”) can provision its respective board with memory from the array's global memory 128. For example, the EDS 140 can uniformly carve out at least one global memory section into x-sized memory portions 300a-n-301a-n. Further, the EDS 140 can size each global memory section or the x-sized memory portions 300a-n-301a-n to store data structure filters like cuckoo filters. The EDS 140 can size each global memory section or the x-sized portions based on an IO workload's predicted metrics related to the amount and frequency of sequential IO write patterns. For instance, the predicted metrics can define the amount of data the x-sized memory portions 300a-n-301a-n can be required to store.

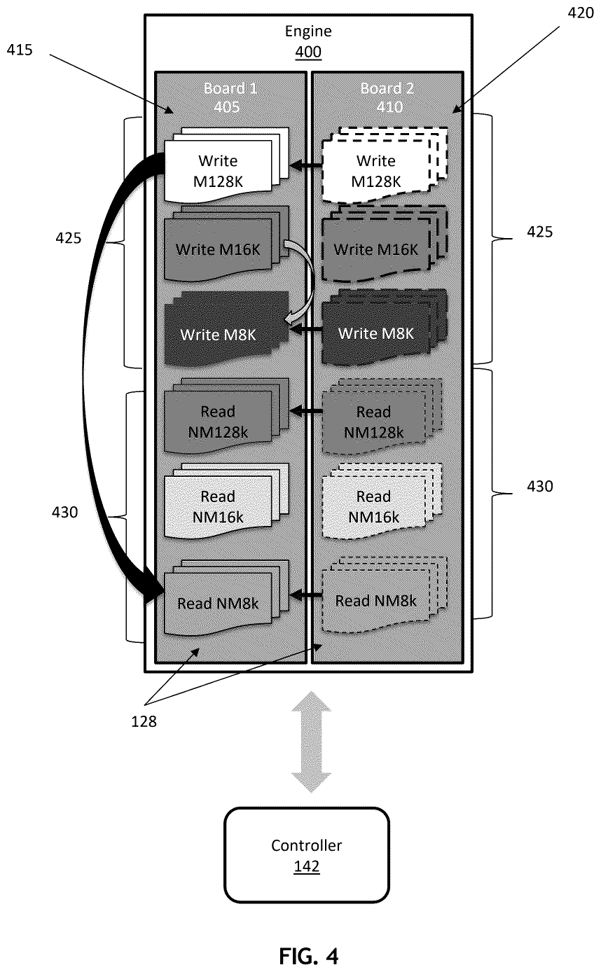

Regarding FIG. 4, a controller 142 can be configured to manage global memory 128 of, e.g., the storage array 102 of FIG. 1. The storage array 102 can include an engine 400 (e.g., substantially like the engines 312a-n of FIG. 3) comprising one or more director boards 405/410 that supply the global memory 128. The global memory 128 can include cache memory 415 stored on a first board 405 and cache memory 420 stored on a second board 410. In the storage array architecture, a board refers to a hardware component containing memory segments that can be either local or remote relative to where IO operations are received and processed. An engine, also called a blade, is a higher-level component that contains two boards and provides the processing infrastructure for the storage array.

Remote boards can exist in two distinct configurations within the storage array. First, a remote board can be located on the same engine as the local board, providing lower latency access but with more limited bandwidth capacity. Second, a remote board can be on a different engine, offering higher bandwidth capabilities despite requiring additional network hops. For example, the director board 405 can correspond to a local board that is receiving and processing IO operations, while the director board 410 can correspond to a remote board. Although the remote board 410 is illustrated as being on the same engine as the local board 405, it can be located on a different engine (e.g., the engine 312n of FIG. 3).

In embodiments, the controller 142 can establish different sizes of mirrored and non-mirrored cache memory segments 425/430 from the global memory 128 to efficiently handle varying types of IO operations. For example, the controller 142 can establish mirrored segments 425 for writes and non-mirrored segments for reads, with three size categories, e.g., 8 Kilobytes (K), 16K, and 128K.

For mirrored operations, the controller 142 can maintain M8K, M16K, and M128K segments 425, where the “M” prefix indicates a mirrored configuration requiring double the memory for redundancy. Similarly, for non-mirrored operations (e.g., reads), the controller uses NM8K, NM16K, and NM128K segments 430.

In embodiments, the controller 142 can select segment sizes to match different application workloads. For example, smaller 16K segments are optimized for transaction processing workloads like banking transactions, while larger 128K segments are designed for sequential operations like backup processes. The 8K segments are typically used for smaller block operations such as system boot processes.

The controller 142 can establish the segments 425/430 across local and remote director boards 405/410. Each board 415/420 can maintain its own set of mirrored and non-mirrored segments 425/430, allowing for flexible resource allocation during IO operations. The segments can operate independently or participate in dynamic slot donations during burst periods, depending on the storage array's needs and workload patterns.

In embodiments, the controller 142 can implement long-term cache memory distribution strategies using a dynamic cache balancing (DCB) technique on extended time windows (e.g., 4+ hours), evaluating average IO workload patterns over the entire period to make permanent adjustments to cache pool (segment) sizes based on overall usage trends. However, the DCB technique cannot react to sudden spikes or bursts in IO activity and maintains fixed segment allocations throughout each 4-hour cycle.

For example, short-term IO bursts can occur at a seconds-level timeframe within the longer DCB window, representing sudden, temporary spikes in IO activity within specific segments. Accordingly, these IO bursts can require the controller 142 to implement dynamic, temporary cache slot donations (e.g., within a single board or between boards) to maintain performance and end when the burst activity subsides, typically within minutes.

The key distinction lies in their temporal characteristics and response mechanisms. While DCB makes broad, long-lasting adjustments to overall cache distribution based on averaged workload patterns, the burst handling system enables temporary, targeted cache slot donations, specifically during spike periods. This complementary approach allows the controller 142 to maintain long-term optimization through DCB and short-term performance through dynamic donations during bursts.

Using the DCB technique, the controller 142 takes average measurements over, e.g., the 4-hour window, which flattens out any burst patterns and makes them appear less significant than they actually are. In contrast, using the short-term donation technique, the controller 142 specifically monitors and responds to these burst patterns, enabling cache slots to be shared temporarily between segments to handle the immediate resource demands.

In embodiments, the controller 142 can implement dynamic segment donation within a local board (e.g., the board 405) by continuously monitoring performance statistics, including CPU consumption, segment-level allocations, fault tolerance metrics, and IO profiles corresponding to IO workloads received by the storage array. Using a time-series analysis (e.g., ARIMA), the controller 142 can analyze these statistics to forecast IO burst patterns and their expected durations within the board 405.

For local board operations, the controller 142 identifies source segments with available cache slots and target segments requiring additional capacity. The donation process enables temporary transfers between mirrored segments (e.g., M8K to M16K), non-mirrored segments (e.g., NM16K to NM128K), and between mirrored and non-mirrored segments within the same board (e.g., the board 405).

When determining donation quantities within the board 405, the controller 142 evaluates current and predicted CPU utilization, segment-level allocation patterns, fault tolerance requirements, and IO profiles of both source and target cache segments. The controller 142 pre-formats memory banks in both source and target segments during forecasted idle periods, and signals when transferred slots are ready for use using any known and yet-to-be-known signaling technique.

In embodiments, the controller 142 can maintain these donations only for the duration of the IO burst, operating independently from but alongside the existing dynamic cache balancing (DCB) technique. While DCB handles long-term cache distribution across longer time windows (e.g., 4+ hours), the controller 142 implements a short-term donation technique that specifically addresses short-term IO bursts by enabling dynamic slot sharing that lasts only for the burst duration.

This process repeats every minute as the controller 142 continuously monitors and adjusts donations based on updated forecasts within the board 405. The controller's local board donation mechanism significantly improves system performance by reducing CPU cycle usage, minimizing unnecessary bandwidth consumption, and enhancing fault tolerance during high-demand periods.

For cross-board cache donations, the controller 142 can implement a sophisticated monitoring and forecasting system that operates across a local board 405 and a remote board 410. Although the remote board 410 is depicted as being on the same engine as the local board 405, a skilled artisan understands that the remote board 405 can reside on another engine (e.g., engine 312n of FIG. 3) of the storage array. Using a time series analysis (e.g., ARIMA), the controller 142 continuously collects and analyzes performance statistics, including CPU consumption, fabric bandwidth usage, segment-level allocations, fault tolerance metrics, and IO profiles from all boards of the storage array (e.g., on the engine 400 and other engines).

When the controller 142 detects that all segments on the local board 405 are fully utilized, it can initiate a remote board donation process. The controller 142 can first evaluate whether to access boards on the same engine (offering lower latency but reduced bandwidth) or different engines (providing higher bandwidth despite increased hop count). This decision is based on the forecasted IO burst characteristics and current system conditions.

For remote board donations, the controller 142 determines both source and target segments across boards, calculating the optimal degree of donations per board based on the predicted burst patterns. The controller 142 specifically considers fabric bandwidth availability when planning cross-board transfers, as these operations require traversing different IVR (Inter-VM Routing) hardware and fabric connections.

Before initiating cross-board transfers, the controller 142 pre-formats memory banks in the target boards during forecasted idle periods. The controller 142 coordinates this pre-formatting to minimize the impact on ongoing IO operations and optimize fabric bandwidth usage. Once pre-formatting is complete, the controller 142 signals that the transferred slots are ready for use by the required boards.

In embodiments, the controller 142 can maintain these cross-board donations only for the duration of the IO burst, terminating the transfers when the burst subsides. This temporary nature of donations, combined with the controller's continuous monitoring and adjustment cycle, ensures efficient resource utilization while preventing cascading performance degradation that can occur when cache resources are constrained during burst periods.

The key distinction between accessing boards on the same engine versus different engines lies in the hardware paths and fabric connections used. Accessing any remote board requires traversing different IVR (Inter-VM Routing) hardware and fabric connections. However, cross-engine transfers utilize what is characterized as a “super high highway with bigger bandwidth,” though with increased hop count, while same-engine transfers provide faster latency but more constrained bandwidth.

The system actively monitors and considers these architectural differences when making donation decisions. It evaluates multiple factors, including fabric bandwidth availability, CPU consumption, and board-level statistics, to optimize slot donations between local and remote boards, taking into account whether the remote board is on the same or different engine. This comprehensive evaluation ensures optimal performance whether donating cache slots within an engine or across different engines in the storage array.

In embodiments, the controller 142 can be any one of a variety of commercially available processors, such as an Intel-based processor, and the like. In embodiments, the controller 142 can be a parallel processor, such as a graphical processing unit (GPU).

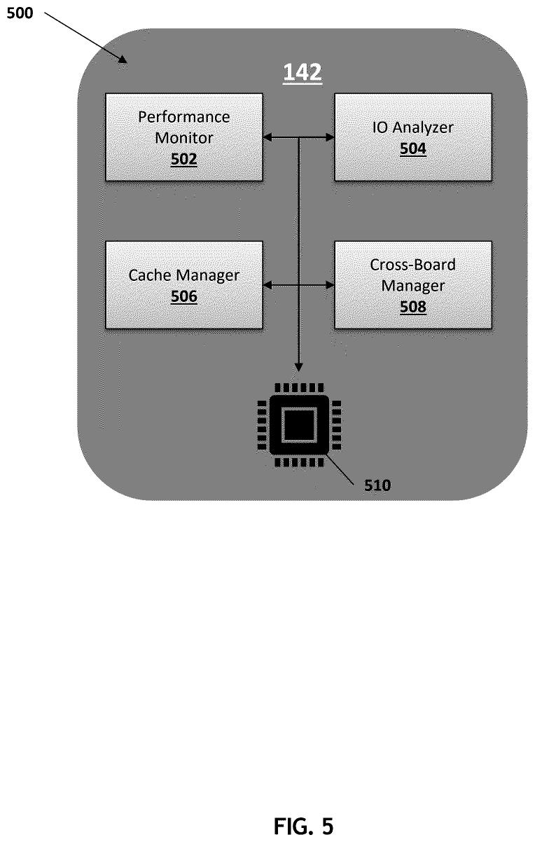

Regarding FIG. 5, a storage array (e.g., the storage array 102 of FIG. 1) can include a controller 142, including logic, hardware, and circuitry 500 that implements a sophisticated cache management system that enables dynamic donation of cache slots between segments during IO bursts.

In embodiments, the controller 142 can include a performance monitor 502 that can leverage a local memory 510 to continuously track and analyze system metrics for enabling intelligent cache slot donations during IO bursts. For example, the monitor 502 can collect metrics, including CPU consumption data, fabric bandwidth utilization statistics, segment-level cache slot allocation information, fault tolerance levels, and IO profiles for each segment (e.g., segments 425/430 of FIG. 4) of global memory (e.g., GM 128 of FIG. 1).

For instance, the performance monitor 502 continuously tracks and analyzes system metrics to enable intelligent cache slot donations during IO bursts. It collects key metrics, e.g., every minute, including CPU consumption across boards, fabric bandwidth utilization, segment-level cache slot allocations, fault tolerance levels for each segment, and IO profiles and patterns.

The performance monitor 502 can maintain, in the local memory 510, rolling windows of historical performance data to enable trend analysis and pattern detection. This historical data is essential for a time series analysis (e.g., ARIMA) that predicts upcoming IO bursts and their characteristics. The monitor 502 can organize the local memory 510 into separate regions for different metric types, allowing efficient access and updates during the minute-by-minute collection cycles.

Through continuous tracking, the monitor 502 samples performance metrics at regular intervals to detect changes in system behavior and identify burst patterns. Additionally, the monitor 502 processes the collected statistics to track segment utilization patterns, identify potential donation sources and targets, calculate optimal donation quantities, and determine transfer timing windows.

In embodiments, the monitor 502 predicts the timing of upcoming IO bursts, estimates burst durations, forecasts idle CPU periods, and identifies available bandwidth windows. For resource assessment, the monitor 502 evaluates current segment utilization, assesses fabric bandwidth capacity, measures CPU consumption levels, and tracks memory bank status.

The performance monitor 502 can also store pre-computed donation schedules and transfer parameters, including source and target segment mappings, donation quantities, and timing windows in the local memory 510. These pre-computed values enable quick lookups during burst periods without requiring additional processing. The monitor 502 can use dedicated memory sections to track the status of ongoing donations, storing signals about pre-formatted memory banks and transfer completion states.

For cross-board operations, the monitor 502 can maintain, in the local memory 510, fabric bandwidth availability maps and remote board statistics, enabling efficient coordination of donations between boards. The memory structure can include separate regions for tracking local and remote transfer states, allowing parallel management of donations within and across boards.

In embodiments, the monitor 502 implements a circular buffer in the local memory 510 to maintain the most recent performance metrics while automatically discarding outdated data. This approach ensures efficient memory utilization while preserving the temporal data needed for accurate burst prediction and donation management. When the monitor detects the conclusion of a burst period, it uses local memory to store completion signals and coordinate the termination of donations across affected segments

In embodiments, the performance monitor 502 can integrate with other system components 500 by providing real-time metrics to the donation scheduler, signaling when transfers can begin, monitoring transfer completion, and triggering donation termination when bursts conclude. This enables efficient coordination of cache slot donations between segments and boards during IO burst periods while maintaining system stability and performance.

In embodiments, the controller 142 can include an IO analyzer 504 that employs a time-series analysis (e.g., ARIMA) to predict and manage IO bursts across cache memory segments. The analyzer 504 processes performance statistics collected from the performance monitor 502 to forecast IO activity patterns and determine optimal cache slot donations.

For example, working at a short-term granularity level (e.g., seconds-level granularity) rather than a traditional longer-term time window (e.g., 4+ hours), the IO analyzer 504 evaluates multiple metrics simultaneously to generate accurate burst predictions. It processes segment-level fault tolerance data, IO profiles, slot allocation patterns, CPU consumption metrics, and fabric bandwidth utilization to identify potential burst periods and their expected durations.

For each predicted burst, the analyzer 504 determines source and target cache segments (e.g., the segments 425/430 of FIG. 4) for cache slot donations. It calculates the optimal degree of donations by evaluating current segment utilization levels and forecasted IO demands. This analysis extends across local board segments and remote boards when additional resources are needed.

The analyzer 504 implements sophisticated forecasting algorithms to identify idle CPU periods and available bandwidth windows, enabling proactive cache slot transfers before burst periods begin. It coordinates with the system's donation scheduler (e.g., a cache manager 506) to ensure transfers occur during these optimal windows, minimizing impact on system performance.

When analyzing cross-board donations, the IO analyzer 504 evaluates fabric bandwidth capacity and potential transfer paths to determine the most efficient donation routes. It considers the differences between accessing remote boards within the same engine versus across different engines, accounting for varying bandwidth capabilities and latency impacts.

The analyzer 504 continuously updates its predictions (stored in the local memory 510) based on real-time performance data, allowing it to adjust donation recommendations as system conditions change. It signals when transfers should begin and end, coordinating with other system components 500 to ensure smooth transitions during burst periods.

Through this comprehensive analysis approach, the IO analyzer 504 enables efficient cache resource management during IO bursts while maintaining system stability and performance. Its predictions and recommendations help prevent the performance degradation typically associated with unmanaged IO bursts in traditional cache management systems.

In embodiments, the controller 142 can include a cache manager 506 that can execute core cache slot donation operations during IO bursts, working in concert with the performance monitor 502 and IO analyzer 504 to optimize system performance. The cache manager 506 handles cache slot transfers between segments based on forecasted burst patterns, coordinating local and remote donations to maintain efficient memory utilization.

When an IO burst is predicted, the cache manager 506 pre-formats memory banks in the source segments before initiating transfers. This preparation ensures the receiving segments can immediately utilize the donated cache slots when the burst occurs. The manager 506 coordinates these pre-formatting operations across both mirrored and non-mirrored segments, handling the additional complexity of mirrored transfers, which require double the cache slots

For local board operations, the cache manager 506 executes transfers between segments of varying sizes (e.g., 8K, 16K, 128K) while maintaining fault tolerance levels. It manages donations between mirrored and non-mirrored segments and cross-type transfers between them. The manager ensures these transfers are complete before the predicted burst window begins

When local resources are insufficient, the cache manager 506 coordinates cross-board donations by working with remote boards. It manages the fabric band width utilization during these transfers, considering the different characteristics of accessing boards within the same engine versus across different engines. The manager 506 accounts for varying bandwidth capabilities and latency impacts when scheduling these remote transfers.

Throughout the burst period, the cache manager 506 monitors the transfer completion status and coordinates with other system components 500 to signal when donated slots are ready for use. When the burst window concludes, the manager 506 orchestrates the return of donated cache slots to their original segments, ensuring smooth transitions that maintain system stability.

The cache manager 506 implements sophisticated scheduling algorithms to coordinate all these operations while minimizing the impact on system performance. It works at a seconds-level granularity rather than traditional hours-long windows, enabling rapid response to changing IO patterns while maintaining efficient resource utilization across the entire system.

In embodiments, the controller 142 can include a cross-board manager 508 that can orchestrate cache slot donations between boards and engines during IO bursts, enabling efficient resource sharing across the system's distributed architecture. The cross-board manager 508 evaluates remote board availability and coordinates transfers by analyzing CPU consumption, fabric bandwidth utilization, and segment-level allocations across all connected boards.

When local board resources are insufficient, the cross-board manager 508 determines suitable remote boards for donations by assessing their current utilization and capacity to provide cache slots. It considers the different characteristics of accessing boards within the same engine versus across different engines, accounting for varying bandwidth capabilities and latency impacts. The cross-board manager 508 evaluates fabric bandwidth capacity and potential transfer paths to determine the most efficient donation routes between boards.

For each cross-board donation, the cross-board manager 508 coordinates the pre-formatting of memory banks on target boards during forecasted burst windows. It signals when pre-formatted banks are ready for consumption and manages the transfer timing to minimize the impact on fabric bandwidth and system performance.

The cross-board manager 508 handles both mirrored and non-mirrored segment transfers across boards, accounting for the additional complexity of mirrored transfers, which require double the cache slots.

The cross-board manager 508 implements sophisticated scheduling algorithms to coordinate transfers during optimal idle CPU and fabric bandwidth windows. It monitors transfer completion status and orchestrates the return of donated slots when burst periods conclude. The cross-board manager 508 maintains awareness of system-wide resource utilization through continuous monitoring of board statistics and segment-level metrics, e.g., using data stored in the local memory 510.

Working at a seconds-level granularity rather than traditional hours-long windows, the cross-board manager 508 enables rapid response to changing IO patterns while maintaining efficient resource utilization across the distributed system. It coordinates with other system components 500 to ensure smooth transitions during burst periods and prevent cascading performance degradation typically associated with unmanaged cross-board resource competition

Although what is described herein shows details of logic, hardware, and circuitry 500 that may reside in the controller 142, all or portions of the illustrated components may also reside elsewhere in the storage array (e.g., one or more of the storage array's components 108 of FIG. 1).

The following text includes details of a method(s) or a flow diagram(s) per embodiments of this disclosure. For simplicity of explanation, each method is depicted and described as a set of alterable operations. Additionally, one or more operations can be performed in parallel, concurrently, or in a different sequence. Further, not all the illustrated operations are required to implement each method described by this disclosure.

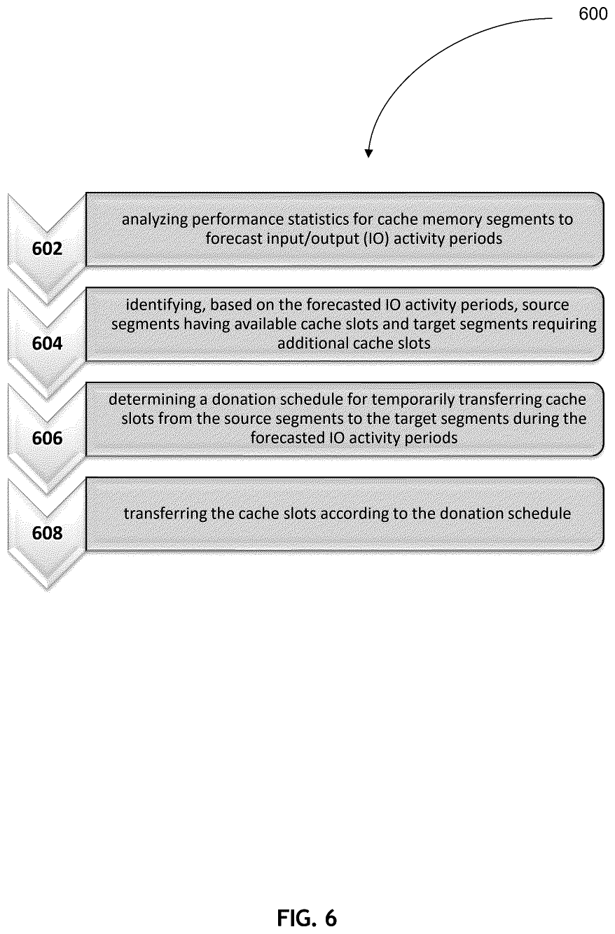

Regarding FIG. 6, a method 600 relates to dynamically managing cache slot allocations in a storage system. In embodiments, the controller 142 of FIG. 1 can perform all or a subset of operations corresponding to the method 600.

For example, the method 600, at 602, can include analyzing performance statistics for cache memory segments to forecast input/output (IO) activity periods.

Additionally, at 604, the method 600 can include identifying, based on the forecasted IO activity periods, source segments having available cache slots and target segments requiring additional cache slots. Further, the method 600, at 606, can include determining a donation schedule for temporarily transferring cache slots from the source segments to the target segments during the forecasted IO activity periods. At 608, the method 600 can include transferring the cache slots according to the donation schedule.

Further, each operation can include any combination of techniques implemented by the embodiments described herein. Additionally, one or more of the storage array's components 108 can implement one or more of the operations of each method described above.

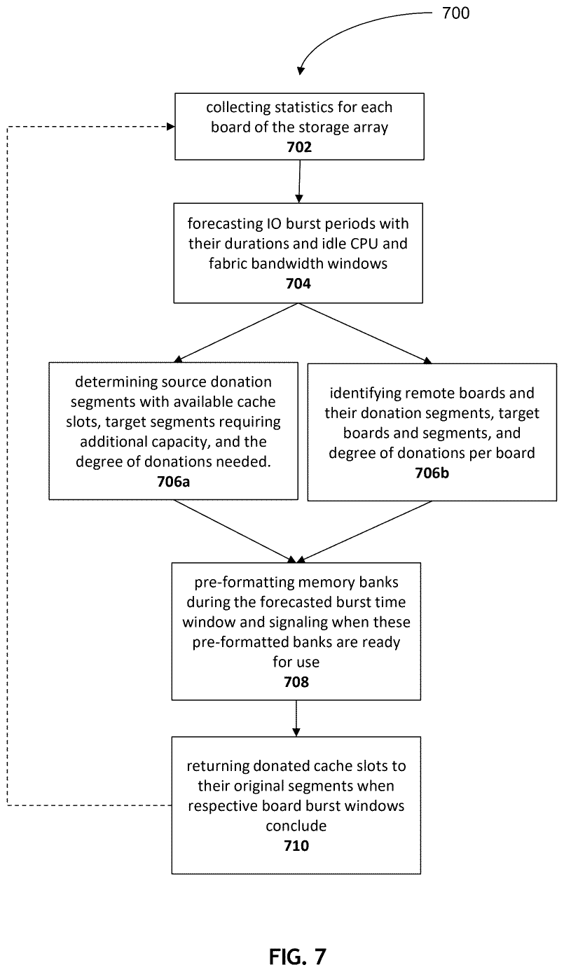

Regarding FIG. 7, a method 700 relates to enabling coordinated cache slot donations between local and remote boards of a storage system (e.g., the storage array 102 of FIG. 1). In embodiments, the controller 142 of FIG. 1 can perform all or a subset of operations corresponding to the method 700. For instance, the controller 142 can implement a continuous monitoring and forecasting process that operates at both the local board and remote board levels.

In embodiments, the method 700, at 702, can include collecting per-board statistics, such as gathering critical metrics, including CPU consumption, fabric bandwidth consumption, segment-level allocations, segment FTT (fault tolerance), and IO profiles. At 704, the method 700 can include forecasting IO burst periods with their durations and idle CPU and fabric bandwidth windows. For example, the method 700, at 704, can include performing a time-series analysis (e.g., AutoRegressive Integrated Moving Average (ARIMA) analysis) using the collected statistics to generate two key forecasts: the expected IO burst periods with their durations and the predicted idle CPU and fabric bandwidth time windows. This forecasting is crucial for proactively managing cache resources before performance degradation occurs.

For local board operations, the method 700, at 706a, can include determining source donation segments with available cache slots, target segments requiring additional capacity, and the degree of donations needed. In parallel, for remote board operations, the method 700, at 706b, can include identifying remote boards and their donation segments, target boards and segments, and degree of donations per board. Once the determinations and identifications corresponding to the local and remote boards are made, the method 700, at 708, can include pre-formatting memory banks during the forecasted burst time window and signaling when these pre-formatted banks are ready for use.

Both local and remote board operations continue until their respective burst time windows conclude; at this point, the method 700, at 710, can include returning donated cache slots to their original segments when respective board burst windows conclude.

In embodiments, the method 700 can repeat periodically (e.g., every minute) to ensure responsive adaptation to changing IO patterns. This frequent iteration allows the system to maintain optimal cache slot allocation throughout IO burst periods.

This dynamic approach differs significantly from traditional static cache management by actively monitoring and responding to IO bursts in near real-time, rather than waiting for longer periodic adjustments. The method's ability to pre-format memory banks and coordinate donations across both local and remote boards enables efficient handling of burst periods while minimizing impact on overall system performance

The method 700 ensures efficient cache slot utilization by enabling donations between mirrored-to-mirrored segments, non-mirrored-to-non-mirrored segments, and even between mirrored and non-mirrored segments when appropriate. This flexibility, combined with the minute-by-minute monitoring and adjustment cycle, provides optimal cache resource management during IO burst periods.

Further, each operation can include any combination of techniques implemented by the embodiments described herein. Additionally, one or more of the storage array's components 108 can implement one or more of the operations of each method described above.

Using the teachings disclosed herein, a skilled artisan can implement the above-described systems and methods in digital electronic circuitry, computer hardware, firmware, or software. The implementation can be a computer program product. Additionally, the implementation can include a machine-readable storage device for execution by or to control the operation of a data processing apparatus. The implementation can, for example, be a programmable processor, a computer, or multiple computers.

A computer program can be in any programming language, including compiled or interpreted languages. The computer program can have any deployed form, including a stand-alone program, subroutine, element, or other units suitable for a computing environment. One or more computers can execute a deployed computer program.

One or more programmable processors can perform the method steps by executing a computer program to perform the concepts described herein by operating on input data and generating output. An apparatus can also perform the steps of the method. The apparatus can be a special-purpose logic circuitry. For example, the circuitry is an FPGA (field-programmable gate array) or an ASIC (application-specific integrated circuit). Subroutines and software agents can refer to portions of the computer program, the processor, the special circuitry, software, or hardware that implements that functionality.

Processors suitable for executing a computer program include, by way of example, both general and special purpose microprocessors and any one or more processors of any digital computer. A processor can receive instructions and data from a read-only memory, a random-access memory, or both. Thus, for example, a computer's essential elements are a processor for executing instructions and one or more memory devices for storing instructions and data. Additionally, a computer can receive data from or transfer data to one or more mass storage device(s) for storing data (e.g., magnetic, magneto-optical disks, solid-state drives (SSDs, or optical disks).

Data transmission and instructions can also occur over a communications network. Information carriers that embody computer program instructions and data include all nonvolatile memory forms, including semiconductor memory devices. The information carriers can, for example, be EPROM, EEPROM, flash memory devices, magnetic disks, internal hard disks, removable disks, magneto-optical disks, CD-ROM, or DVD-ROM disks. In addition, the processor and the memory can be supplemented by or incorporated into special-purpose logic circuitry.

A computer with a display device enabling user interaction can implement the above-described techniques, such as a display, keyboard, mouse, or any other input/output peripheral. The display device can, for example, be a cathode ray tube (CRT) or a liquid crystal display (LCD) monitor. The user can provide input to the computer (e.g., interact with a user interface element). In addition, other kinds of devices can enable user interaction. Other devices can, for example, be feedback provided to the user in any form of sensory feedback (e.g., visual feedback, auditory feedback, or tactile feedback). For example, input from the user can be in any form, including acoustic, speech, or tactile input.

A distributed computing system with a back-end component can also implement the above-described techniques. The back-end component can, for example, be a data server, a middleware component, or an application server. Further, a distributing computing system with a front-end component can implement the above-described techniques. The front-end component can, for example, be a client computer with a graphical user interface, a web browser through which a user can interact with an example implementation, or other graphical user interfaces for a transmitting device. Finally, the system's components can interconnect using any form or medium of digital data communication (e.g., a communication network). Examples of communication network(s) include a local area network (LAN), a wide area network (WAN), the Internet, a wired network(s), or a wireless network(s).

The system can include a client(s) and server(s). The client and server (e.g., a remote server) can interact through a communication network. For example, a client-and-server relationship can arise when computer programs run on the respective computers and have a client-server relationship. Further, the system can include a storage array(s) that delivers distributed storage services to the client(s) or server(s).

Packet-based network(s) can include, for example, the Internet, a carrier internet protocol (IP) network (e.g., local area network (LAN), wide area network (WAN), campus area network (CAN), metropolitan area network (MAN), home area network (HAN)), a private IP network, an IP private branch exchange (IPBX), a wireless network (e.g., radio access network (RAN), 802.11 network(s), 802.16 network(s), general packet radio service (GPRS) network, HiperLAN), or other packet-based networks. Circuit-based network(s) can include, for example, a public switched telephone network (PSTN), a private branch exchange (PBX), a wireless network, or other circuit-based networks. Finally, wireless network(s) can include RAN, Bluetooth, code-division multiple access (CDMA) networks, time division multiple access (TDMA) networks, and global systems for mobile communications (GSM) networks.

The transmitting device can include, for example, a computer, a computer with a browser device, a telephone, an IP phone, a mobile device (e.g., cellular phone, personal digital assistant (PDA) device, laptop computer, electronic mail device), or other communication devices. The browser device includes, for example, a computer (e.g., desktop computer, laptop computer) with a World Wide Web browser (e.g., Microsoft® Internet Explorer® and Mozilla®). The mobile computing device includes, for example, a Blackberry®.

Comprise, include, or plural forms of each are open-ended, include the listed parts, and contain additional unlisted elements. Unless explicitly disclaimed, the term ‘or’ is open-ended and includes one or more of the listed parts, items, elements, and combinations thereof.

1. A method comprising:
analyzing performance statistics for cache memory segments at a seconds-level granularity using a time-series analysis to generate: a first forecast identifying expected IO burst periods and their durations; and a second forecast identifying predicted idle CPU processing periods and available fabric bandwidth windows;
identifying, based on the first forecast, source segments having available cache slots and target segments requiring additional cache slots;
determining a donation schedule for temporarily transferring cache slots from the source segments to the target segments during the expected IO burst periods, wherein the donation schedule schedules the cache slot transfers to occur during the idle CPU processing periods and available fabric bandwidth windows identified in the second forecast; and
transferring the cache slots according to the donation schedule.

2. The method of claim 1, further comprising:
predicting a time and duration of IO bursts using a time-series analysis.

3. The method of claim 1, wherein the performance statistics include at least one of: CPU consumption, bandwidth consumption, segment-level allocations, fault tolerance, and IO profiles.

4. The method of claim 1, wherein transferring cache slots comprises transferring between at least one of: mirrored segments, non-mirrored segments, and mirrored and non-mirrored segments.

5. The method of claim 1, wherein determining the donation schedule comprises:
identifying idle processing periods and available bandwidth windows; and
scheduling cache slot transfers during the identified idle periods.

6. The method of claim 1, further comprising:
pre-formatting memory banks in the source segments before transferring the cache slots.

7. The method of claim 1, wherein transferring cache slots comprises:
transferring cache slots between segments on a same board; and
transferring cache slots between segments on different boards.

8. The method of claim 1, further comprising:
signaling when transferred cache slots are ready for use; and
terminating the transfers when the forecasted IO activity period concludes.

9. The method of claim 1, wherein analyzing performance statistics comprises:
monitoring IO activity within individual boards; and
monitoring IO activity across multiple boards.

10. The method of claim 1, wherein determining the donation schedule comprises determining a quantity of cache slots to transfer based on forecasted IO activity levels.

11. An apparatus with a memory and processor, the apparatus configured to:
analyze performance statistics for cache memory segments at a seconds-level granularity using a time-series analysis to generate: a first forecast identifying expected IO burst periods and their durations; and a second forecast identifying predicted idle CPU processing periods and available fabric bandwidth windows;
identify, based on the first forecast, source segments having available cache slots and target segments requiring additional cache slots;
determine a donation schedule for temporarily transferring cache slots from the source segments to the target segments during the expected IO burst periods, wherein the donation schedule schedules the cache slot transfers to occur during the idle CPU processing periods and available fabric bandwidth windows identified in the second forecast; and
transfer the cache slots according to the donation schedule.

12. The apparatus of claim 11, further configured to:
predicting a time and duration of IO bursts using a time-series analysis.

13. The apparatus of claim 11, wherein the performance statistics include at least one of: CPU consumption, bandwidth consumption, segment-level allocations, fault tolerance, and IO profiles.

14. The apparatus of claim 11, wherein transferring cache slots comprises transferring between at least one of: mirrored segments, non-mirrored segments, and mirrored and non-mirrored segments.

15. The apparatus of claim 11, wherein determining the donation schedule comprises:
identifying idle processing periods and available bandwidth windows; and
scheduling cache slot transfers during the identified idle periods.

16. The apparatus of claim 11, further configured to:
pre-formatting memory banks in the source segments before transferring the cache slots.

17. The apparatus of claim 11, wherein transferring cache slots comprises:
transferring cache slots between segments on a same board; and
transferring cache slots between segments on different boards.

18. The apparatus of claim 11, further configured to:
signaling when transferred cache slots are ready for use; and
terminating the transfers when the forecasted IO activity period concludes.

19. The apparatus of claim 11, wherein analyzing performance statistics comprises:
monitoring IO activity within individual boards; and
monitoring IO activity across multiple boards.

20. The apparatus of claim 11, wherein determining the donation schedule comprises determining a quantity of cache slots to transfer based on forecasted IO activity levels.
